(19) United States
(12) Patent Application Publication
(10) Pub. No.: US 2023/0304218 A1
(43) Pub. Date: Sep. 28, 2023

(54) COMPOSITION FOR ECO-FRIENDLY ARTIFICIAL LEATHER HAVING COFFEE GROUNDS WITH BIODEGRADABLE AND DEODORIZING EFFECT, ARTIFICIAL LEATHER INCLUDING SAME AND MANUFACTURING METHOD THEREOF

(71) Applicants: HYUNDAI MOTOR COMPANY, Seoul (KR); KIA CORPORATION, Seoul (KR); KOLONGLOTECH, INC., Seoul (KR)

(72) Inventors: Gun Kang, Seoul (KR); Hye Min Lee, Suwon-si (KR); Ji Soo Kwon, Gumi-si (KR); Jong Hwan Kim, Daegu (KR); Gu Seong Kim, Daegu (KR)

(73) Assignees: HYUNDAI MOTOR COMPANY, Seoul (KR); KIA CORPORATION, Seoul (KR); KOLONGLOTECH, INC., Seoul (KR)

(21) Appl. No.: 17/993,446

(22) Filed: Nov. 23, 2022

(30) Foreign Application Priority Data
Mar. 28, 2022 (KR) 10-2022-0037882

(51) Int. Cl. D06N 3/00; D06N 3/06; D06N 3/14; B32B 5/02; D06N 3/12; B32B 5/24; B32B 5/20; B32B 37/24; C08L 27/06; C08L 75/04

(52) U.S. Cl. CPC D06N 3/0061; D06N 3/06; D06N 3/14; D06N 3/0011; B32B 5/022; D06N 3/121; B32B 5/245; B32B 5/20; B32B 37/24; C08L 27/06; C08L 75/04; D06N 2209/1614; D06N 2203/068; D06N 2203/048; D06N 2209/067; D06N 2203/063; D06N 3/0077; B32B 2307/7163; B32B 2307/54; B32B 2264/062; B32B 2266/0235; B32B 2266/0278; B32B 2255/26; B32B 2255/102; B32B 2037/243; B32B 2369/00; B32B 2327/06; B32B 2375/00; B32B 2305/20; B32B 2305/022; C08L 2205/03; C08L 2310/00

(57) ABSTRACT

The present disclosure relates to artificial leather. More specifically, the present disclosure relates to biodegradable and odorless artificial leather including coffee grounds. A composition for artificial leather includes a first resin, a first plasticizer, and a masterbatch including a second resin, a second plasticizer, and coffee grounds. The artificial leather includes a sheet layer including the composition disclosed herein.

### CROSS REFERENCE TO RELATED APPLICATION

The present application claims priority to Korean Patent Application No. 10-2022-0037882, filed Mar. 28, 2022, the entire contents of which is incorporated herein for all purposes by this reference.

### BACKGROUND

### 1. Technical Field

The present disclosure relates to artificial leather. More specifically, the present disclosure relates to biodegradable and odorless artificial leather comprising coffee grounds.

### 2. Description of the Related Art

Only 0.2% of coffee is extracted from coffee beans, and the remaining 99.8% is discharged as coffee grounds. In 2018, domestic coffee imports amounted to 158,385 tons, and annual imports show a steady increase. This results in a large amount of coffee grounds every year. Coffee grounds are mainly dumped at landfills or incinerated. It has a negative effect on the environment and is expensive to process.

Therefore, there are currently many attempts to utilize coffee grounds in various fields.

If coffee grounds are simply introduced during the process of producing artificial leather, the coffee grounds are not uniformly dispersed in the artificial leather. Therefore, the mechanical strength, such as tensile strength and elongation of artificial leather, is deteriorated.

### SUMMARY

An objective of the present disclosure is to provide an artificial leather having excellent mechanical properties, excellent biodegradability, and no odor.

The objective of the present disclosure is not limited to the objective mentioned above. The objective of the present disclosure will become more apparent from the following description and will be realized by means and combinations thereof described in the claims and equivalents thereof.

The composition for artificial leather, according to an embodiment of the present disclosure, may include a first resin, a first plasticizer, and a masterbatch.

The masterbatch may include a second resin, a second plasticizer, and coffee grounds.

The first resin and the second resin may respectively include at least one of polyvinyl chloride (PVC) and polyurethane (PU).

The first plasticizer and the second plasticizer may respectively include at least one of diisodecyl phthalate, dipropyl-heptyl phthalate, trioctyl trimellitate, diisononyl phthalate, and diisononyl adipate.

The coffee grounds may have a water activity of about 0.3 or less.

The masterbatch may include an amount of about 40 parts by weight to 100 parts by weight of the second plasticizer and an amount of about 50 parts by weight to 80 parts by weight of the coffee grounds based on 100 parts by weight of the second resin.

The masterbatch may have a particle size (D50) of about 200 μm to 300 μm.

The composition may include an amount of about 40% to 55% by weight of the first resin, an amount of about 30% to 45% by weight of the first plasticizer, and an amount of about 3% to 20% by weight of the masterbatch.

The composition may further include an amount of about 0.1% to 1% by weight of a biodegradation accelerator.

The artificial leather, according to an embodiment of the present disclosure, may include: a sheet layer including the composition, a backing layer including a nonwoven fabric disposed on one surface of the sheet layer; and a skin layer disposed on the other surface of the sheet layer.

The sheet layer may include a plurality of layers, at least one layer among the plurality of layers may be a foam layer.

The manufacturing method for artificial leather, according to an embodiment of the present disclosure, may include: preparing a masterbatch including a second resin, a second plasticizer, and coffee grounds; preparing a mixture by kneading a first resin, a first plasticizer, and the masterbatch; and preparing a sheet layer comprising the mixture.

The preparing of the mixture may include preparing a first kneaded product including kneading the first resin and the first plasticizer at a temperature of about 150° C. to 170° C. for about 2 to 3 minutes, adding the masterbatch to the first kneaded product, and kneading the masterbatch and the first kneaded product at a temperature of about 150° C. to 170° C. for about 2 to 3 minutes to prepare the mixture.

The preparing of the mixture may further include adding a biodegradation accelerator together with the masterbatch.

The manufacturing method may further include laminating a backing layer, including a nonwoven fabric on one surface of the sheet layer and forming a skin layer on the other surface of the sheet layer.

The method may further include foaming the sheet layer.

According to the present disclosure, it is possible to obtain artificial leather having excellent mechanical properties, excellent biodegradability, and generated odor during process reduction effects.

The effects of the present disclosure are not limited to the effects mentioned above. It should be understood that the effects of the present disclosure include all effects that can be inferred from the following description.

### BRIEF DESCRIPTION OF THE DRAWINGS

FIG. 1 shows a cross-sectional view of an artificial leather according to the present disclosure;

FIG. 2 shows the degree of disintegration of artificial leather according to the comparative example; and

FIG. 3 shows the degree of disintegration of artificial leather according to an embodiment of the present disclosure.

### DETAILED DESCRIPTION

The above objectives, other objectives, features, and advantages of the present disclosure will be easily understood through the following preferred embodiments in conjunction with the accompanying drawings. However, the present disclosure is not limited to the embodiments described herein and may be embodied in other forms. Rather, the embodiments introduced herein are provided so that the disclosed content may be thorough and complete, and the spirit of the present disclosure may be sufficiently conveyed to those skilled in the art.

Like reference numerals have been used for like elements in describing each figure. In the accompanying drawings, the dimensions of the structures are enlarged than the actual size for clarity of the present disclosure. Terms such as first, second, etc., may be used to describe various elements, but the elements should not be limited by the terms. The above terms are used only for the purpose of distinguishing one component from another. For example, without departing from the scope of the present disclosure, a first component may be referred to as a second component, and similarly, a second component may also be referred to as a first component. The singular expression includes the plural expression unless the context clearly dictates otherwise.

In this specification, the terms “include” or “have” should be understood to designate that one or more of the described features, numbers, steps, operations, components, or a combination thereof exist, and the possibility of addition of one or more other features or numbers, operations, components, or combinations thereof should not be excluded in advance. Also, when a part of a layer, film, region, plate, etc., is said to be “on” another part, this includes not only the case where it is “on” another part but also the case where another part is in the middle. Conversely, when a part of a layer, film, region, plate, etc., is said to be “under” another part, this includes not only cases where it is “directly under” another part but also a case where another part is in the middle.

Unless otherwise specified, all numbers, values, and/or expressions expressing quantities of ingredients, reaction conditions, polymer compositions, and formulations used herein contain all numbers, values and/or expressions in which such numbers essentially occur in obtaining such values, among others. Since they are approximations reflecting various uncertainties in the measurement, they should be understood as being modified by the term “about” in all cases. In addition, when a numerical range is disclosed in this disclosure, this range is continuous and includes all values from the minimum to the maximum value containing the maximum value of this range unless otherwise indicated. Furthermore, when such a range refers to an integer, all integer, including the minimum value to the maximum value containing the maximum value, are included unless otherwise indicated.

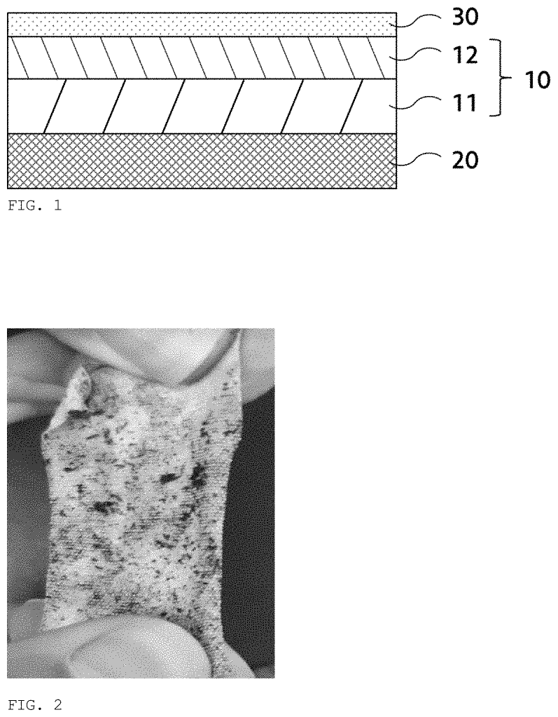

FIG. 1 shows a cross-sectional view showing an artificial leather according to the present disclosure. Referring to FIG. 1, the artificial leather may include: a sheet layer 10; a backing layer disposed on one surface of the sheet layer 10 and including a nonwoven fabric; and a skin layer 30 disposed on the other surface of the sheet layer 10.

The sheet layer 10 may include a plurality of layers. FIG. 1 shows the sheet layer 10 includes the lower layer 11 and the upper layer 12. The structure of the artificial leather according to the present disclosure is not limited thereto, and modified examples such as a plurality of the lower layers 11 or a plurality of the upper layers 12 are included in the scope of the present disclosure.

The present disclosure is characterized in that coffee grounds are recycled by adding coffee grounds to the sheet layer 10, and biodegradable and odorless artificial leather may be obtained.

The coffee grounds may be included in at least one of the lower layer 11 and the upper layer 12. When coffee grounds are added to the lower layer 11, a larger amount can be added, thereby reducing the content of the inorganic filler and enhancing deodorizing effect. When coffee grounds are added to the upper layer 12, biodegradability and deodorizing effect are imparted to the artificial leather, and the coffee grounds can be seen on the surface of the artificial leather, thereby enhancing the aesthetics of the artificial leather.

The sheet layer 10 may be prepared by calendering the composition for artificial leather. The composition for artificial leather may include a first resin, a first plasticizer, and a masterbatch. The masterbatch may include a second resin, a second plasticizer, and coffee grounds.

Each of the first resin and the second resin may include at least one selected from the group consisting of polyvinyl chloride (PVC), polyurethane (PU), and a combination thereof. The first resin and the second resin may be the same as or different from each other. It may be preferable or desirable to use the same resin for the first resin and the second resin to ensure or improve compatibility between the first and second resins.

Each of the first plasticizer and the second plasticizer may include at least one selected from the group consisting of diisodecyl phthalate, dipropyl-heptyl phthalate, trioctyl trimellitate, diisononyl phthalate, diisononyl adipate, and a combination thereof. The first plasticizer and the second plasticizer may be the same as or different from each other.

The coffee grounds are composed of cellulose having a network structure. Accordingly, since biodegradability can be imparted to artificial leather and odor molecules such as chlorophenol generated during the manufacturing process of the sheet layer 10 are adsorbed, it is effective in reducing odor.

When the coffee grounds are simply added to a resin or the like to form a sheet layer, the dispersibility is very poor. Accordingly, in the present disclosure, the coffee grounds are added in the form of a masterbatch so that the coffee grounds can be uniformly dispersed in the sheet layer 10.

The coffee grounds may have a water activity of about 0.3 or less. The water activity refers to the degree of freedom of water contained in the coffee grounds. Water activity may be measured and calculated as follows.

Water activity (Aw)=water vapor pressure of coffee grounds (P)/water vapor pressure of pure water (P₀)

When the water activity of the coffee grounds exceeds 0.3, the amount of water is excessive, and thus the coffee grounds may be agglomerated without being uniformly dispersed in the sheet layer, or formability may be degraded.

The masterbatch may include an amount of about 40 parts by weight to 100 parts by weight of the second plasticizer and an amount of about 50 parts by weight to 80 parts by weight of the coffee grounds based on 100 parts by weight of the second resin. When the content of the second plasticizer and coffee grounds falls within the above ranges, it is possible to obtain a masterbatch in which the coffee grounds are evenly dispersed.

The particle size D50 of the masterbatch may be about 200 μm to 300 μm. The particle size D50 can be adjusted by mechanically milling the masterbatch, which will be described later.

The composition for artificial leather may include an amount of about 40% to 55% by weight of the first resin, an amount of about 30% to 45% by weight of the first plasticizer, and an amount of about 3% to 20% by weight of the masterbatch. When the content of the masterbatch falls within the above range, biodegradability and deodorizing effect can be obtained without degrading the mechanical properties of artificial leather.

The composition for artificial leather may further include additives such as a biodegradation accelerator, a foaming agent, a heat stabilizer, a flame retardant, a pigment, and an inorganic filler.

The biodegradation accelerator may include natural enzymes and the like. The biodegradability of the artificial leather can be further improved by adding the biodegradation accelerator in an amount of about 0.1% to 1% by weight.

The foaming agent is non-toxic, has self-extinguishing properties, and may include a chemical foaming agent for plastics and rubber having excellent storage stability. The foaming agent may include azodicarbonamide.

The heat stabilizer may suppress carbonization due to the desorption of chlorine contained in polyvinyl chloride (PVC), improve productivity, and reinforce weather resistance and heat resistance. The heat stabilizer may include zeolite, zinc stearate, and the like.

The flame retardant may increase the flame retardancy of the artificial leather. The flame retardant may include antimony trioxide (Sb₂O₃) and the like.

The pigment is used for the purpose of coloring the artificial leather and may include a color imparting component and an adhesive force imparting component.

The inorganic filler may include at least one selected from the group consisting of talc, calcium carbonate, silica, and a combination thereof.

The backing layer 20 may include a nonwoven fabric. The backing layer 20 may increase the durability of the artificial leather.

The skin layer 30 may be formed by coating the sheet layer 10 with a polycarbonate-based or polyurethane-based surface treatment agent. The skin layer 30 may prevent the coffee grounds of the sheet layer 10 from falling off, or prevent the coffee grounds from contamination due to exposure to moisture in the air.

The manufacturing method for artificial leather, according to the present disclosure, may include: preparing a masterbatch including a second resin, a second plasticizer, and coffee grounds; preparing a mixture by kneading a first resin, a first plasticizer, and the masterbatch; and preparing the sheet layer using the mixture.

First, the coffee grounds may be dried in order to lower the water activity of the coffee grounds to about 0.3 or less. Drying conditions are not particularly limited, for example, the coffee grounds may be dried at a temperature of about 80° C. for at least about 24 hours.

The method for preparing the masterbatch is not particularly limited, and after kneading the second resin and the second plasticizer, coffee grounds are added to the resultant and further kneaded, or the second resin, the second plasticizer, and the coffee grounds can be mixed and kneaded together. Considering the dispersibility of the coffee grounds, it may be preferable to prepare the masterbatch by the former method.

As described above, after kneading the second resin, the second plasticizer, and coffee grounds, the resultant is mechanically milled to obtain the masterbatch having a particle size (D50) of about 200 μm to 300 μm. The milling method is not particularly limited, and the milling can be performed by methods such as ball mill, air jet mill, bead mill, roll mill, planetary mill, hand milling, high energy ball mill, planetary mill ball mill, stirred ball mill, vibrating mill, mechanofusion milling, shaker milling, and attritor milling, disk milling, shape milling, NAUTA milling, NOBILTA milling, high-speed mix, and the like.

Next, the mixture may be prepared by kneading the first resin, the first plasticizer, and the masterbatch. Specifically, the mixture may be prepared by primary kneading the first resin and the first plasticizer at a temperature of about 150° C. to 170° C. for about 2 to 3 minutes, adding the masterbatch to the resultant product, and secondary kneading at a temperature of about 150° C. to 170° C. for about 2 to 3 minutes.

The sheet layer 10 may be prepared by calendering the mixture. The thickness of the sheet layer 10 is not particularly limited but may be adjusted to about 0.2 mm or more, or about 0.25 mm or more, or about 0.3 mm or more in order to prevent the coffee grounds from falling off.

The backing layer 20 may be laminated on one surface of the sheet layer 10, and the skin layer 30 may be formed on the other surface of the sheet layer 10.

The laminating method is not particularly limited, and the backing layer 20 may be laminated through a calendaring method or the like. However, it may be preferable to laminate at a temperature of about 150° C. to 180° C. so that organic material in the coffee grounds of the sheet layer 10 is not deformed.

The skin layer 30 may be formed by gravure coating the other surface of the sheet layer 10 with a polycarbonate-based surface treatment agent, a polyurethane-based surface treatment agent, or the like, and then evaporating an aqueous solvent.

In addition, after forming the skin layer 30, the artificial leather is compressed with a roller on which the grain is imprinted to implement a design such as embossing on the surface of the artificial leather. Even at this time, it may be preferable to press the artificial leather at a temperature of about 150° C. to 180° C. so as not to deform the organic material in the coffee grounds.

The manufacturing method for artificial leather, according to the present disclosure, may further include foaming the sheet layer 10. The sheet layer 10 may include a plurality of layers, and at least one layer among the plurality of layers may be a foaming layer. The foaming layer may further include a foaming agent as an additive. By adjusting the content of the foaming agent, the thickness of the foamed sheet layer 10 may increase about 100% to 400%. Foaming of the sheet layer 10 may be performed after forming the backing layer and the skin layer 30 or may be performed before that.

Hereinafter, embodiments of the present disclosure will be described in more detail through the following examples. The following examples are merely illustrative to help the understanding of the present disclosure, and the scope of the present disclosure is not limited thereto.

Examples and Comparative Examples

Artificial leather was prepared according to the composition and manufacturing method described above. Specifically, an artificial leather, including a sheet layer 10 composed of a lower layer 11 and an upper layer 12 as shown in FIG. 1, was prepared using the composition shown in Table 1 below.

TABLE 1

| | Example | | Comparative Example | |
|---|---|---|---|---|
| | Upper | Lower | Upper | Lower |
| Composition | layer | layer | layer | layer |
| First resin [wt %] | 40 to 55 | 35 to 45 | 35 to 40 | 40 to 50 |
| Plasticizer [wt %] | 30 to 45 | 30 to 35 | 35 to 45 | 35 to 40 |
| Foaming agent [wt %] | — | 0.5 to 3 | — | 0.5 to 3 |
| Heat stabilizer [wt %] | 1 to 3 | 1 to 2 | 1 to 3 | 1 to 2 |
| Masterbatch [wt %] | 3 to 8 | 10 to 20 | — | — |
| Flame retardant [wt %] | 0.3 to 0.8 | 3 to 6 | 0.3 to 0.8 | 3 to 6 |
| Pigment [wt %] | 4 to 6 | 0.5 to 1 | 4 to 6 | 0.5 to 1 |
| Inorganic filler [wt %] | — | — | — | 10 to 15 |
| Biodegradation | 0.5 to 1 | 0.5 to 1 | — | — |
| accelerator [wt %] | | | | |

Specific compounds of each composition in Table 1 are as follows.
First resin: Polyvinyl Chloride (PVC)
Plasticizers: Diisodecyl phthalate (DIDP)
Foaming agent: Azodicarbonamide
Heat Stabilizer: Zeolite and Zinc stearate
Masterbatch: Prepared by kneading polyvinyl chloride (PVC), diisodecyl phthalate (DIDP) and coffee grounds, the particle size (D50) is 200 to 300 μm
Flame retardant: Antimony trioxide (Sb₂O₃)

The basic physical properties, odor, and eco-friendliness of artificial leather, according to Examples and Comparative Examples, were evaluated as shown in Tables 2 and 3 below.

TABLE 2

| | Eco-friendliness | | |
|---|---|---|---|
| | Biocarbon | Degree of | |
| Division | measurement | disintegration | Biodegradability |
| Standard | ASTM D6866-10 | KS T ISO | ASTM D5511, |
| | | 20200: 2017 | 90 DAYS |
| Example | 9.4% | 7% | 15.4% |
| Comparative | 0% | 0.6% | — |
| Example | | | |

TABLE 3

| | | Basic physical properties | | |
|---|---|---|---|---|
| | Odor | Static load | Heat aging | Friction |
| Division | Smell | elongation | resistance | resistance |
| Standard | MS 300-34 | MS 321-16: 2020 | | |
| Example | 3 to 3.5 | 59% | 4.5 level | 4 level |
| Comparative | 4 to 4.5 | 63% | 4.5 level | 4 level |
| Example | | | | |

Referring to Table 2, as a result of radiocarbon dating (ASTM D6866-10) the artificial leather according to the Example, the content of bio-carbon (C-14), an isotope, was increased by adding coffee grounds.

In addition, it can be seen that the Example, including the coffee grounds and the biodegradation accelerator, had superior biodegradability compared to the Comparative Example.

Biodegradability was measured by the two standards: degree of disintegration (KS T ISO 20200: 2017) and biodegradability (ASTM D5511, 90 DAYS).

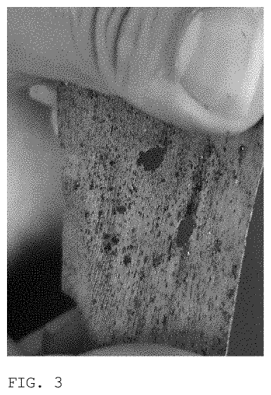

FIG. 2 shows the degree of disintegration of the artificial leather according to the Comparative Example. When the fabric of

Comparative Example exposed for 3 months under the disintegration conditions (KS T ISO 20200: 2017) was stretched by hand, the sheet form was fully preserved, and the weight reduction due to disintegration was also insignificant at 0.6%.

FIG. 3 shows the degree of disintegration of the artificial leather according to the Example. When the fabric of Example was exposed to disintegration conditions (KS T ISO 20200: 2017) for 3 months in the same manner as the Comparative Example and was stretched by hand as shown in FIG. 3, the fabric was easily broken, and the weight reduction due to disintegration was 7%, about 11 times higher than that of the Comparative Example.

Referring to Table 2, the Example shows a high biodegradability of 15%.

Referring to Table 3, it can be seen that the Example is effective in reducing odor by adsorbing odor molecules of chlorophenols generated during the polyvinyl chloride (PVC) manufacturing process by adding coffee grounds made of cellulose having a network structure. In addition, the inherent aroma of coffee was also added, and as a result, the odor rating evaluation (MS300-34) was improved by one grade compared to the Comparative Example.

As described above in detail, the scope of the present disclosure is not limited to the above-described embodiments, and various modifications and improvements of those skilled in the art using the basic concept of the present disclosure defined in the following claims and equivalents thereof are also included in the scope of the present disclosure.

What is claimed is:

1. A composition for artificial leather, the composition comprising:
a first resin;
a first plasticizer; and
a masterbatch comprising a second resin, a second plasticizer, and coffee grounds.

2. The composition of claim 1, wherein the first resin and the second resin respectively comprises at least one of polyvinyl chloride and polyurethane.

3. The composition of claim 1, wherein the first plasticizer and the second plasticizer respectively comprises at least one of diisodecyl phthalate, dipropyl-heptyl phthalate, trioctyl trimellitate, diisononyl phthalate, and diisononyl adipate.

4. The composition of claim 1, wherein the coffee grounds have a water activity of about 0.3 or less.

5. The composition of claim 1, wherein the masterbatch comprises an amount of about 40 to 100 parts by weight of the second plasticizer and an amount of about 50 to 80 parts by weight of the coffee grounds based on 100 parts by weight of the second resin.

6. The composition of claim 1, wherein the masterbatch has a particle size (D50) of about 200 to 300 μm.

7. The composition of claim 1, comprising:
an amount of about 40% to 55% by weight of the first resin;
an amount of about 30% to 45% by weight of the first plasticizer; and
an amount of about 3% to 20% by weight of the masterbatch.

8. The composition of claim 1, further comprising an amount of about 0.1% to 1% by weight of a biodegradation accelerator.

9. An artificial leather comprising a sheet layer comprising the composition of claim 1.

10. The artificial leather of claim 9, wherein the sheet layer comprises a plurality of layers, and at least one layer among the plurality of layers is a foaming layer.

11. The artificial leather of claim 9, wherein the artificial leather further comprises:
a backing layer disposed on one surface of the sheet layer and comprising a nonwoven fabric; and
a skin layer disposed on the other surface of the sheet layer.

12. A manufacturing method for artificial leather, the method comprising:
preparing a masterbatch comprising a second resin, a second plasticizer, and coffee grounds;
preparing a mixture by kneading a first resin, a first plasticizer, and the masterbatch; and
preparing a sheet layer comprising the mixture.

13. The method of claim 12, wherein the first resin and the second resin respectively comprises at least one of polyvinyl chloride and polyurethane, and
the first plasticizer and the second plasticizer respectively comprises at least one of diisodecyl phthalate, dipropyl-heptyl phthalate, trioctyl trimellitate, diisononyl phthalate, and diisononyl adipate.

14. The method of claim 12, wherein the coffee grounds have a water activity of about 0.3 or less.

15. The method of claim 12, wherein the masterbatch comprises an amount of about 40 to 100 parts by weight of the second plasticizer and an amount of about 50 to 80 parts by weight of the coffee grounds based on 100 parts by weight of the second resin, and
the masterbatch has a particle size (D50) of about 200 to 300 μm.

16. The method of claim 12, wherein the preparing of the mixture includes:
preparing a first kneaded product including kneading the first resin and the first plasticizer at a temperature of about 150° C. to 170° C. for about 2 to 3 minutes,
adding the masterbatch to the first kneaded product, and
kneading the masterbatch and the first kneaded product at a temperature of about 150° C. to 170° C. for about 2 to 3 minutes to prepare the mixture.

17. The method of claim 16, wherein the preparing of the mixture further includes:
adding a biodegradation accelerator together with the masterbatch.

18. The method of claim 12, wherein the mixture comprises:
an amount of about 40% to 55% by weight of the first resin;
an amount of about 30% to 45% by weight of the first plasticizer; and
an amount of about 3% to 20% by weight of the masterbatch.

19. The method of claim 12, further comprising:
laminating a backing layer comprising a nonwoven fabric on one surface of the sheet layer; and
forming a skin layer on the other surface of the sheet layer.

20. The method of claim 12, further comprising foaming the sheet layer.
